(19) United States
(12) Patent Application Publication
(10) Pub. No.: US 2011/0088265 A1
(43) Pub. Date: Apr. 21, 2011

(54) KITCHEN UTENSIL

(76) Inventor: James P. Madren, Reidsville, NC (US)

(21) Appl. No.: 12/580,183

(22) Filed: Oct. 15, 2009

(51) Int. Cl. B26B 3/00

(52) U.S. Cl. 30/169

(57) ABSTRACT

A kitchen utensil for food preparation which utensil includes an elongate body of uniform width having a top portion, a bottom portion, at least two sides, and a first end and a second end. The first end has a tapered straight edge. The second end has a rounded edge or a rounded tapered edge. The kitchen utensil is a multifunctional tool for ergonomic stirring, scraping, pounding, flipping, and other like process for preparing food.

### BACKGROUND

This invention relates generally to a kitchen utensil which is normally used in the preparation of food.

A type of kitchen utensil, commonly referred to as “kitchenware,” includes such items as spatulas and spoons of various configurations. Kitchenware is used to scrape and stir the bottom and edges of containers. Additionally, these utensils are also used to flip, pound, cut, and separate food.

Current kitchenware, while helpful in food preparation, can be ineffective in stirring and scraping the sides and bottoms of containers by leaving portions of food behind. Furthermore, kitchenware, due to its shape and size, can be difficult to hold and maneuver. This problematic handling of the kitchenware can lead to joint and body strain.

For the foregoing reasons, there is the need for a new kitchen utensil that is both ergonomic and multifunctional in its use and handling.

### SUMMARY

A kitchen utensil is provided, comprising an elongate body of uniform width having an elongate exterior top, an elongate exterior bottom, at least two sides each having an exterior surface, a first end and a second end. The top has a surface which is substantially planar substantially throughout the elongate longitudinal length and transverse width of the elongate body. The bottom has a surface which is substantially planar substantially throughout the elongate longitudinal length and transverse width of the elongate body. The sides have a planar exterior surface extending generally longitudinally along and substantially perpendicular to the top and bottom. The first end has a tapered straight edge and the second end has a rounded edge.

### BRIEF DESCRIPTION OF THE DRAWINGS

For a more complete understanding of the present invention, reference should now be made to the embodiments shown in the accompanying drawings and described below. In the drawings:

FIG. 1 is a perspective view of an embodiment of a kitchen utensil.

FIG. 2 is a top view of the kitchen utensil shown in FIG. 1.

FIG. 3 is an end view of the kitchen utensil shown in FIG. 1.

FIG. 4 is another end view of the kitchen utensil shown in FIG. 1.

FIG. 5 is a side view of the kitchen utensil shown in FIG. 1.

FIG. 6 is a bottom view of the kitchen utensil shown in FIG. 1.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

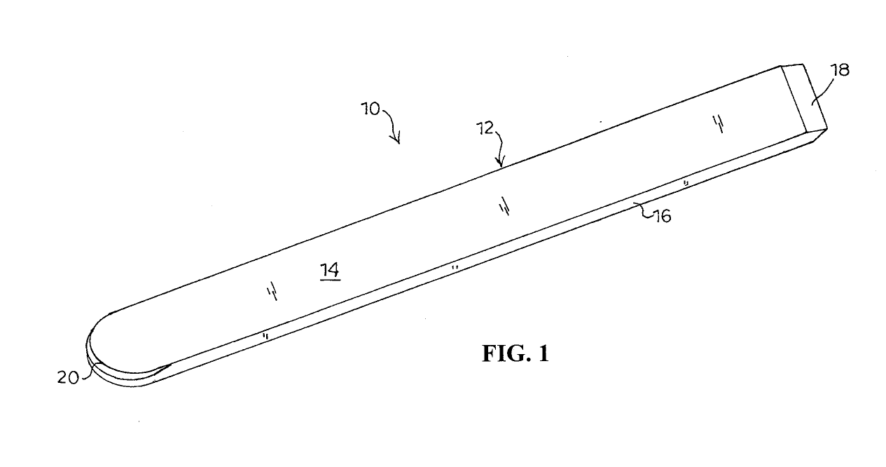

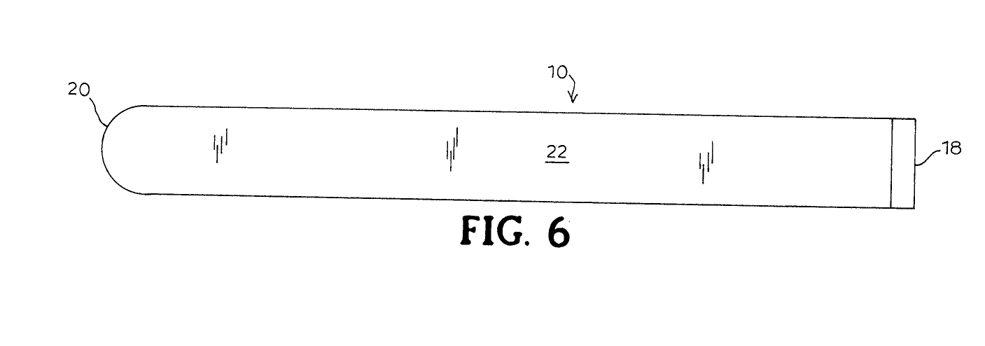

Referring now to the drawings, wherein like reference numerals designate corresponding or similar elements throughout the several views, FIGS. 1-6 show an embodiment of a kitchen utensil, generally designated at 10. The kitchen utensil 10 comprises an elongate body 12, an elongate exterior bottom 22, an elongate exterior top 14, and exterior sides 16. The elongate body 12 is preferably about 6 to about 18 inches in length, but may vary to accommodate use, such as stirring in deep containers. At a length of less than about six inches, the utensil barely extends beyond the hand of the user when gripped in the entire palm. At lengths temperatures greater than about 18 inches, the utensil becomes unwieldy and the user loses leverage, especially in highly viscous materials.

The elongate body is uniform in width throughout its length. The body 12 is preferably 1-3″ in width, but may vary according to the user's hand size. For example, a person with smaller than average hands would preferably use the kitchen utensil 10 with the elongate body 12 of about 1″ to ensure minimum strain to the fingers and wrist. At a width of less than about one inch, the utensil becomes difficult to grip, particularly for larger hands. Moreover, because the utensil has a uniform width along its length, a utensil having a width of about one inch will not provide a large surface for moving material. Widths greater than about three inches are also difficult to grip because they tend to be too large even for a person with large hands.

The kitchen utensil 10 is formed from wood. The preferred material of construction is maple wood, which provides both strength and flexibility to the kitchen utensil 10. However, the present invention is not limited to maple wood, and other materials such as cherry wood, plastic, metal, or other suitable materials may be appropriate. The scope of the invention is not intended to be limited by the materials listed here, but may be carried out using any material which allows the construction and use of the kitchen utensil 10 described herein.

As shown in FIGS. 1, 2 and 6, the top 14 and bottom 22 surfaces have a smooth and generally flat, or planar surface, that extends over substantially the entire top and bottom area, respectively, of the elongate body 12. The top 14 is generally parallel to the bottom 22 and generally perpendicular to the sides 16.

With reference now to FIG. 3, the sides 16 of the kitchen utensil are straight and substantially perpendicular to the top and bottom surfaces, which intersect with the sides 16 to form edges 24. The edges 24 may be rounded or straight. The sides extend along the length of the elongate body 12 and merge with a tapered first end 18 and a rounded second end 20. In one embodiment, the sides 16 have the same thickness along the length. The sides 16 are preferably about ⅛ inches to about 5/16 inches thick. A utensil at the lower end of the range has some flexibility depending on the material of the stick. Above about 5/16 inches, the utensil loses its flexibility and becomes more difficult to grip

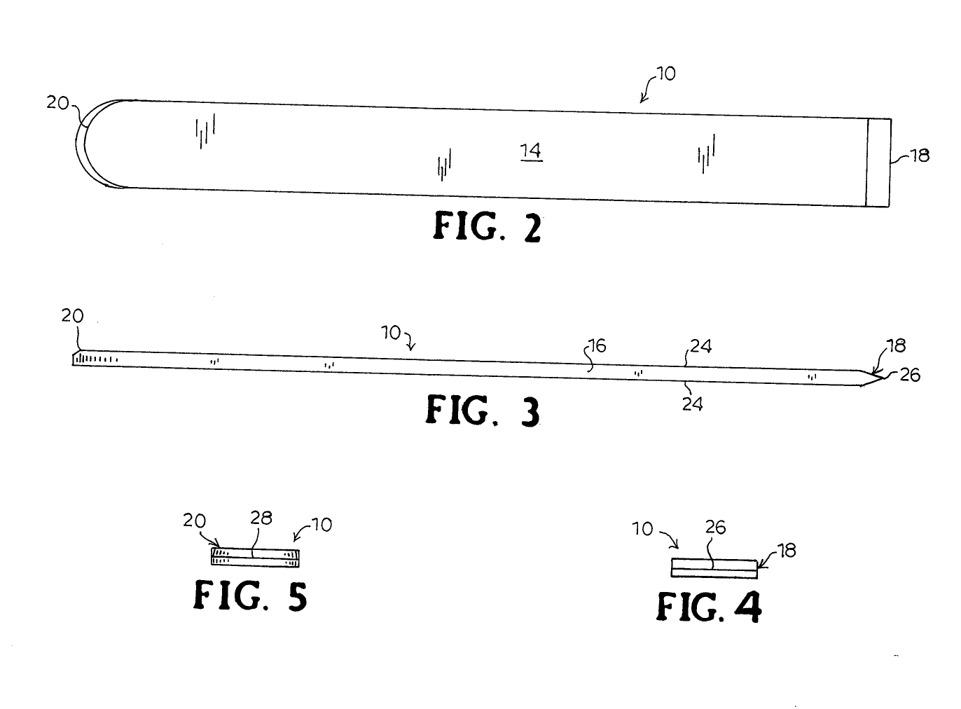

As shown in FIGS. 2-4, the first end of the elongate body 12 gradually thins or tapers into a straight edge 26. The first end 18 may be singly or doubly tapered, as shown. As shown in FIGS. 2, 3, and 5, the second end 20 of the elongate body 12 gradually thins or tapers into a rounded edge 28. The second end 20 may be singly tapered, as shown, or doubly tapered. Furthermore, in another embodiment the second end 20 may have no taper.

The kitchen utensil 10 is a multifunctional utensil that may be used for pounding, shaping, scraping, stirring, flipping, or other like process. The tapered first end 18 can be used to scrape food particles off of cookware and does not mar non-stick surfaces when the kitchen utensil is made of wood, Teflon, or the like. The second rounded end 20 can be used for flipping food. The rounded second end 20 is particularly useful in separating substances that are hard to break apart such as frozen vegetables by pushing through the frozen vegetables with the second end 20 without having to resort to twisting motions. This allows the frozen materials to become separated while minimizing wrist strain. Either end can be used to pound or jab food.

The flat top 14 and bottom 22 surfaces of the utensil make the kitchen utensil 10 particularly useful in handling (e.g. stirring, scraping, and flipping) solid or semi-sold substances such as macaroni and cheese because the food does not tend to cling to the flat surfaces. Moreover, the flat surface of the top 14, bottom 22, and the sides 16 are easy to clean as there are no crevices, slots, or indentations to trap particles. Also, the straight edges 24 of sides 16 make it particularly useful for scraping the side of a circular container without leaving particles or other material on the sides. The uniform width of the kitchen utensil 10 provides the user with a large gripping surface so that the utensil remains firmly within the user's hand. The uniform width of the elongate body 12 allows the user to grip the utensil between the thumb and all four fingers with the body resting in the heel of the hand. This uniform width of the elongate 12 body allows the kitchen utensil 10 to be used for stirring with little or no movement of the wrist while minimizing the gripping strain of the fingers. The width of the elongate body 12 is also particularly useful in moving a large volume of liquid when the kitchen utensil is used for stirring.

Moreover, the uniform width of the elongate body 12 and the flat surfaces of the top 14, the bottom 22, and the sides 16 leads to efficient production of the kitchen utensils as it allows the utensil to be constructed with minimal waste.

Although the present invention has been shown and described in considerable detail with respect to only a few exemplary embodiments thereof, it should be understood by those skilled in the art that I do not intend to limit the invention to the embodiments since various modifications, omissions and additions may be made to the disclosed embodiments without materially departing from the novel teachings and advantages of the invention, particularly in light of the foregoing teachings. For example, the kitchen utensil may be used in a number of applications where stirring, scraping, jabbing, and like processes are used. Accordingly, I intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

I claim:

1. A kitchen utensil, comprising:
an elongate body of uniform width, the body having an elongate exterior bottom, an elongate exterior top, at least two sides each having an exterior surface, a first end and a second end;
the top having a surface which is substantially planar substantially throughout the elongate longitudinal length and transverse width of the body;
the bottom having a surface which is substantially planar substantially throughout the elongate longitudinal length and transverse width of the body;
the sides having a planar exterior surface extending generally longitudinally along and substantially perpendicular to the top and the bottom;
the first end having a tapered straight edge; and
the second end having a rounded edge.

2. A kitchen utensil as recited in claim 1, wherein the second end comprises a tapered rounded edge.

3. A kitchen utensil as recited in claim 1, wherein the kitchen utensil is composed of wood.

4. A kitchen utensil as recited in claim 1, wherein the kitchen utensil is composed of plastic.

5. A kitchen utensil as recited in claim 6, wherein the kitchen utensil is composed of metal.
